(19) United States
(12) Patent Application Publication
(10) Pub. No.: US 2017/0075462 A1
(43) Pub. Date: Mar. 16, 2017

(54) TOUCH SCREEN PANEL AND TOUCH DISPLAY DEVICE

(71) Applicants: BOE TECHNOLOGY GROUP CO., LTD., Beijing (CN); CHENGDU BOE OPTOELECTRONICS TECHNOLOGY CO., LTD., Chengdu, Sichuan Province (CN)

(72) Inventors: Chuan PENG, Beijing (CN); Feng ZHANG, Beijing (CN); Hwang KIM, Beijing (CN); Youqiang LU, Beijing (CN)

(21) Appl. No.: 15/124,665

(22) PCT Filed: Sep. 14, 2015
(86) PCT No.: PCT/CN2015/089527

§ 371 Date: Sep. 8, 2016

(30) Foreign Application Priority Data
Apr. 22, 2015 (CN) 201510194980.8

(51) Int. Cl. G06F 3/041; G02F 1/1333; G06F 3/044

(52) U.S. Cl. CPC G06F 3/0412; G06F 3/044; G02F 1/13338

(57) ABSTRACT

The present disclosure relates to a touch screen panel and a touch display device. Several isolation electrodes are arranged in gaps between adjacent touch electrodes, and the isolation electrodes and the touch electrodes are insulated from each other. Therefore, even if a touch electrode and an adjacent isolation electrode are short-circuited during production, such a short circuit will only integrate the isolation electrode into part of the touch electrode while the isolation electrode is still insulated from other touch electrodes, since the isolation electrode is isolated from both other isolation electrodes and other touch electrodes. In this way, the risk of short circuits in the touch screen panel will be greatly reduced.

### RELATED APPLICATIONS

The present application claims the benefit of Chinese Patent Application No. 201510194980.8, filed on Apr. 22, 2015, the entire disclosure of which is incorporated herein by reference.

### FIELD

The present disclosure relates to the field of touch display technologies, and in particular to a touch screen panel and a touch display device.

### BACKGROUND ART

With rapid development of display technologies, touch screen panels have gradually pervaded people's lives. At present, according to composition structures, touch screen panels can be divided into: Add on Mode touch panels, On Cell touch panels and In Cell touch panels. An Add on Mode touch panel is a liquid crystal display having a touch function, which is formed by separately producing a touch screen panel and a liquid crystal display (LCD) and then bonding them together. As a result, the Add on Mode touch panel has disadvantages such as higher manufacture cost, lower light transmittance and greater module thickness. An In Cell touch panel is made by embedding touch electrodes of a touch screen panel into a liquid crystal display, which no only thins the overall thickness of the modules, but also greatly reduces the manufacture cost for the touch screen panel. Therefore, the In Cell touch panel is favored by various panel producers.

Nowadays, an existing In Cell touch panel mainly achieves detection of position touched by fingers by taking advantage of the principle of mutual capacitance or self capacitance. In the existing In Cell touch panel, the material for the touch electrodes is generally a transparent conductive oxide, e.g., Indium Tin Oxide (ITO). However, since the light transmittance of ITO is not 100% and there is a difference between the refractive index of the touch electrodes and that of a base substrate, accordingly there will be a visual difference between the touch electrodes and the gaps therebetween, which makes patterns of the touch electrodes recognizable by naked eyes.

In the prior art, this visual difference is usually avoided by reducing gap widths. However, as the gap widths between the touch electrodes decrease, the risk for short circuits between the touch electrodes during production will increase. Therefore, how to reduce the risk for short circuits in a touch screen panel while ensuring the display effect is an urgent technical problem to be solved by those skilled in the art.

### SUMMARY

A touch screen panel and a touch display device are provided in embodiments of the present disclosure, for reducing the risk for short circuits in the touch screen panel while ensuring display effects of the touch screen panel.

The touch screen panel provided in the embodiments of the present disclosure comprises several touch electrodes arranged in a same layer and being mutually independent, wherein a plurality of isolation electrodes being mutually independent are arranged at least in gaps between parts of adjacent touch electrodes, the isolation electrodes and the touch electrodes being arranged in a same layer and insulated from each other.

Optionally, in the touch screen panel provided in the embodiments of the present disclosure, opposite sides of the isolation electrodes and the touch electrodes adjacent to each other are parallel.

Optionally, in the touch screen panel provided in the embodiments of the present disclosure, gap widths between the isolation electrodes and the touch electrodes adjacent thereto are smaller than 10 μm.

Optionally, in the touch screen panel provided in the embodiments of the present disclosure, opposite sides of two adjacent ones of the isolation electrodes are parallel.

Optionally, in the touch screen panel provided in the embodiments of the present disclosure, gap widths between two adjacent ones of the isolation electrodes are smaller than 10 μm.

Optionally, in the touch screen panel provided in the embodiments of the present disclosure, widths of the isolation electrodes are smaller than 2000 μm in a first direction and smaller than 1000 μm in a second direction, wherein the first direction is perpendicular to the second direction.

Optionally, in the touch screen panel provided in the embodiments of the present disclosure, opposite sides of two adjacent ones of the touch electrodes are parallel.

Optionally, in the touch screen panel provided in the embodiments of the present disclosure, opposite sides of two adjacent ones of the touch electrodes are all straight lines or polygonal lines.

Optionally, in the touch screen panel provided in the embodiments of the present disclosure, in gaps between the adjacent touch electrodes, at least one column of isolation electrodes are arranged evenly in an extending direction of the gaps, and the respective shapes of the isolation electrodes are rectangular or parallelogrammic.

Optionally, in the touch screen panel provided in the embodiments of the present disclosure, the shapes of the isolation electrodes are triangular, and two of the isolation electrodes form an isolation electrode group, in which three corresponding sides of the two isolation electrodes are parallel respectively. Besides, in the gaps between the adjacent touch electrodes, a column of isolation electrode groups are arranged evenly in an extending direction of the gaps.

Optionally, in the touch screen panel provided in the embodiments of the present disclosure, all of the isolation electrodes are in a same shape and of a same size.

Correspondingly, a touch display device is further provided in the embodiments of the present disclosure. The touch display device comprises any of the above touch screen panels provided in the embodiments of the present disclosure.

According to the touch screen panel and the touch display device provided in the embodiments of the present disclosure, several isolation electrodes are arranged in gaps between adjacent touch electrodes, and the isolation electrodes and the touch electrodes are insulated from each other. Therefore, even if a touch electrode and an adjacent isolation electrode are short-circuited during production, such a short circuit will only integrate the isolation electrode into part of the touch electrode while the isolation electrode is still insulated from other touch electrodes, since the isolation electrode is isolated from both other isolation electrodes and other touch electrodes. In this way, the risk for short circuits in the touch screen panel will be greatly reduced.

### BRIEF DESCRIPTION OF DRAWINGS

FIG. 1a is a schematic structural view I for a touch screen panel provided in the embodiments of the present disclosure;

FIG. 1b is a schematic structural view II for a touch screen panel provided in the embodiments of the present disclosure;

FIG. 1c is a schematic structural view III for a touch screen panel provided in the embodiments of the present disclosure;

FIG. 2a is a schematic structural view IV for a touch screen panel provided in the embodiments of the present disclosure;

FIG. 2b is an enlarged sectional view for the touch screen panel as shown in FIG. 2a;

FIG. 3 is a schematic structural view V for a touch screen panel provided in the embodiments of the present disclosure;

FIG. 4 is a schematic structural view VI for a touch screen panel provided in the embodiments of the present disclosure;

FIG. 5a is a schematic structural view VII for a touch screen panel provided in the embodiments of the present disclosure;

FIG. 5b is a schematic structural view VIII for a touch screen panel provided in the embodiments of the present disclosure; and

FIG. 6 is a schematic structural view IX for a touch screen panel provided in the embodiments of the present disclosure.

### DETAILED DESCRIPTION OF EMBODIMENTS

The specific implementations of the touch screen panel and the touch display device provided in the embodiments of the present disclosure are described in detail as follows with reference to the drawings.

Sizes and shapes for each region in the drawings do not reflect the real ratios, but instead, they are only provided for illustrating contents of the present disclosure.

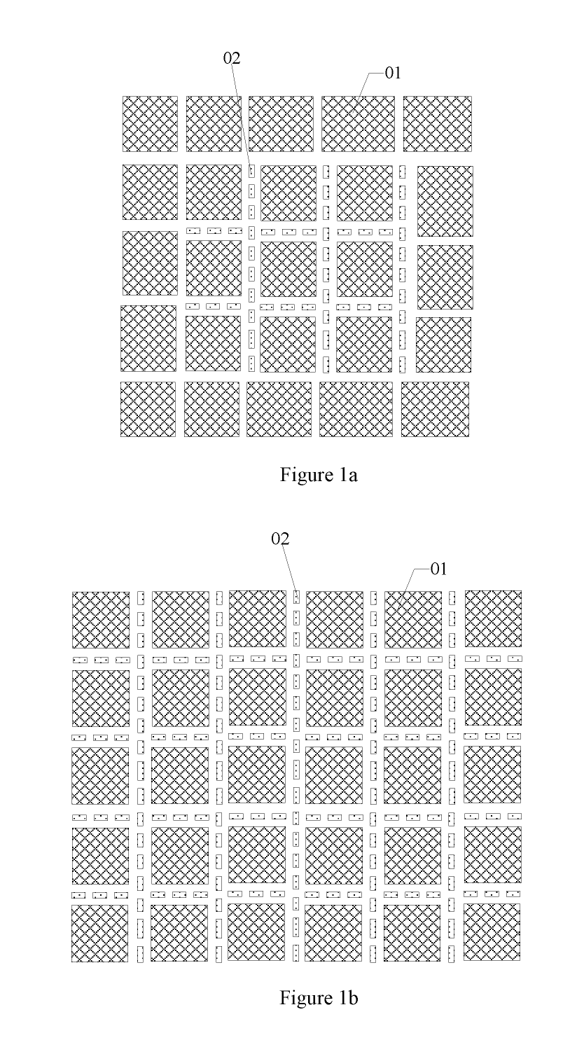

A touch screen panel is provided in the embodiments of the present disclosure. As shown in FIGS. 1a and 1b, the touch screen panel comprises several touch electrodes 01 arranged in a same layer and being mutually independent. A plurality of mutually independent isolation electrodes 02 are arranged at least in gaps between parts of adjacent touch electrodes 01. The isolation electrodes 02 and the touch electrodes 01 are arranged in a same layer and insulated from each other.

According to the touch screen panel provided in the embodiments of the present disclosure, several isolation electrodes are arranged in gaps between adjacent touch electrodes, and the isolation electrodes and the touch electrodes are insulated from each other. Therefore, even if a touch electrode and an adjacent isolation electrode are short-circuited during the manufacture, such a short circuit will only integrate the isolation electrode into part of the touch electrode while the isolation electrode is still insulated from other touch electrodes, since the isolation electrode is isolated from both other isolation electrodes and other touch electrodes. In this way, the risk for short circuits in the touch screen panel will be greatly reduced.

Besides, in the touch screen panel provided in the embodiments of the present disclosure, since the isolation electrodes and the touch electrodes are arranged in a same layer, the manufacture for the isolation electrodes and the touch electrodes can be carried out simultaneously through one patterning process and simply realized by changing a patterning pattern without additional process steps.

Specifically, in the touch screen panel provided in the embodiments of the present disclosure, the isolation electrodes can be arranged only in gaps between adjacent touch electrodes in some preset regions, e.g., in regions where short circuits are apt to occur.

Optionally, in order to ensure evenness and reduce the risk for short circuits in the entire touch screen panel, in the touch screen panel provided in the embodiments of the present disclosure, as shown in FIG. 1b, the isolation electrodes 02 are arranged in gaps between all adjacent touch electrodes 01.

Furthermore, in the touch screen panel provided in the embodiments of the present disclosure, as shown in FIG. 1c, in order to reduce the risk for short circuits in the entire touch screen panel, the isolation electrodes 02 can be arranged in any gap between the touch electrodes 01 arranged in a same layer, regardless of the shapes between the adjacent touch electrodes 01.

Specifically, in specific implementation, the touch screen panel provided in the embodiments of the present disclosure can be either a self capacitance touch screen panel or a mutual capacitance touch screen panel, which will not be limited here. When the touch screen panel is a mutual capacitance touch screen panel, the touch electrodes can be touch inductive electrodes, or touch drive electrodes, or both, which will not be limited here.

Specifically, in specific implementation, in the touch screen panel provided in the embodiments of the present disclosure, the material for the touch electrode can be any transparent conductive material, which will not be limited here. Specifically, in specific implementation, the material for the touch electrodes can be a transparent conductive oxide, graphene, a metal network or the like.

Furthermore, in the touch screen panel provided in the embodiments of the present disclosure, all the isolation electrodes can be in a same shape and of a same size or not, which will not be limited here. Optionally, for convenience of manufacture, all the isolation electrodes are in a same shape and of a same size.

Specifically, in specific implementation, in the touch screen panel provided in the embodiments of the present disclosure, the shapes of the isolation electrodes can be regular shapes such as rectangles, triangles or circles, or irregular shapes of course, which will not be limited here. Optionally, for convenience of manufacture, the shapes of the isolation electrodes are arranged to be regular shapes.

Furthermore, in the touch screen panel provided in the embodiments of the present disclosure, all the isolation electrodes can be distributed in gaps between adjacent touch electrodes either evenly or randomly, which will not be limited here. Optionally, the isolation electrodes are evenly distributed in gaps between adjacent touch electrodes.

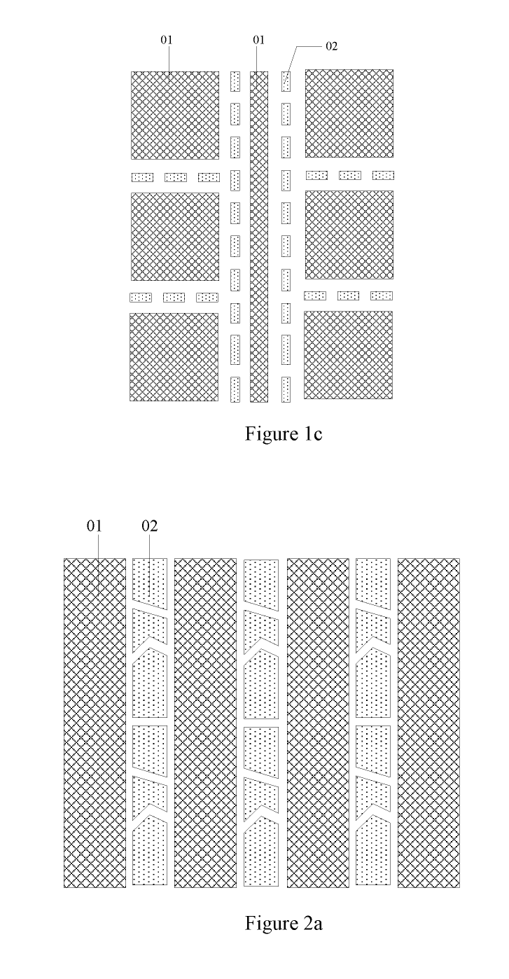

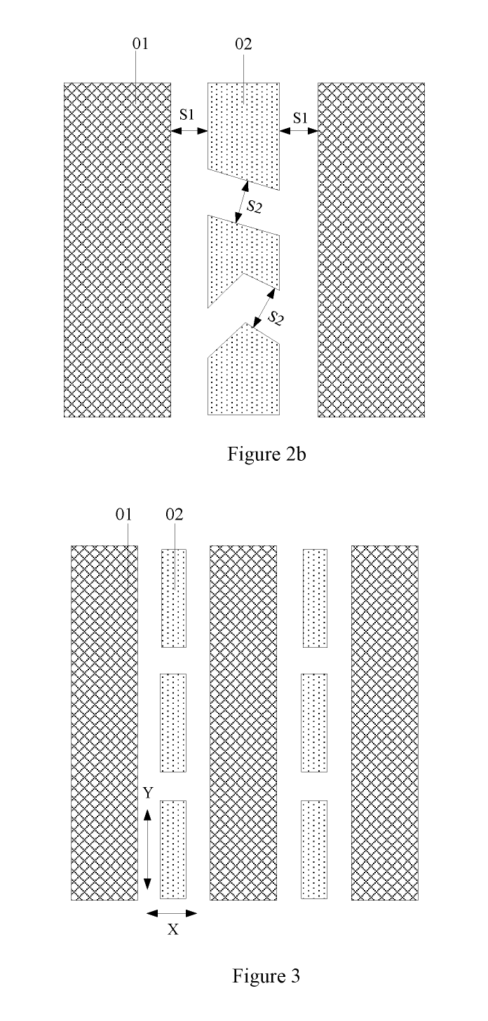

Optionally, in the touch screen panel provided in the embodiments of the present disclosure, in order to facilitate manufacture and ensure evenness of display, as shown in FIGS. 2a and 2b, opposite sides of isolation electrodes 02 and touch electrodes 01 adjacent to each other are parallel. That is, it is required that the sides of the isolation electrodes 02 adjacent to the touch electrodes 01 should be parallel with the corresponding sides of the adjacent touch electrodes. The shapes of the sides of the isolation electrodes not adjacent to the touch electrodes will not be limited here.

Specifically, in specific implementation, in the touch screen panel provided in the embodiments of the present disclosure, as shown in FIG. 2b, the gap widths 51 between the isolation electrodes 02 and the adjacent touch electrodes 01 are smaller than 30 μm, which will not be limited here.

Optionally, in order to prevent the gaps between the touch electrodes and the isolation electrodes from being identifiable for human eyes, in the touch screen panel provided in the embodiments of the present disclosure, the gap widths between the isolation electrodes and the adjacent touch electrodes are arranged to be smaller than 10 μm.

Furthermore, in the touch screen panel provided in the embodiments of the present disclosure, all gap widths between the isolation electrodes and the adjacent touch electrodes are arranged to be equal, which will not be limited here.

Furthermore, in the touch screen panel provided in the embodiments of the present disclosure, in order to facilitate manufacture and ensure evenness of display, as shown in FIGS. 2a and 2b, opposite sides of two adjacent isolation electrodes 02 are parallel.

Specifically, in specific implementation, in the touch screen panel provided in the embodiments of the present disclosure, as shown in FIG. 2b, the gap widths S2 between any two adjacent isolation electrodes 02 are smaller than 30 μm, which will not be limited here.

Optionally, in order to prevent the isolation electrodes and the gaps between the isolation electrodes from being identifiable for human eyes, in the touch screen panel provided in the embodiments of the present disclosure, the gap widths between two adjacent isolation electrodes 02 are arranged to be smaller than 10 μm.

Furthermore, in the touch screen panel provided in the embodiments of the present disclosure, the gap widths between all of the isolation electrodes are arranged to be equal, which will not be limited here.

Optionally, in specific implementation, in the touch screen panel provided in the embodiments of the present disclosure, the gap widths between the isolation electrodes and the adjacent touch electrodes are arranged to be equal to the gap widths between the adjacent isolation electrodes.

Specifically, in specific implementation, in the touch screen panel provided in the embodiments of the present disclosure, the more the isolation electrodes are arranged in the gaps between the touch electrodes, the smaller risk for short circuits they will take. Specifically, the reason for is that when the number of the isolation electrodes is large, the corresponding sizes thereof will be smaller, which will less likely to cause short circuits for the touch electrodes in terms of probability. Therefore, this is a universal processing measure during the design and production of an actual product.

Therefore, in specific implementation, the number of the isolation electrodes can be increased by reducing the sizes of the isolation electrodes. However, the smaller sizes the isolation electrodes have, the more difficult their manufacture becomes. Alternatively, the number of the isolation electrodes can be increased by occupying an area of the touch electrodes. However, this will decrease the number of the touch electrodes, which will in turn affect the touch sensitivity. Therefore, in specific implementation, the number and the sizes of the isolation electrodes can be determined upon actual situation.

In specific implementation, in the touch screen panel provided in the embodiments of the present disclosure, as shown in FIG. 3, the widths of the isolation electrodes 02 are smaller than 2000 μm in a first direction Y, and smaller than 1000 μm in a second direction X. The first direction Y is perpendicular to the second direction X. In specific implementation, the extending direction of the gaps between the adjacent touch electrodes is generally taken as the first direction Y.

Optionally, in specific implementation, in the touch screen panel provided in the embodiments of the present disclosure, when the first direction is the extending direction of the gaps between the adjacent touch electrodes, controlling the widths of the isolation electrodes in the second direction X between 5 μm and 20 μm will achieve better effects.

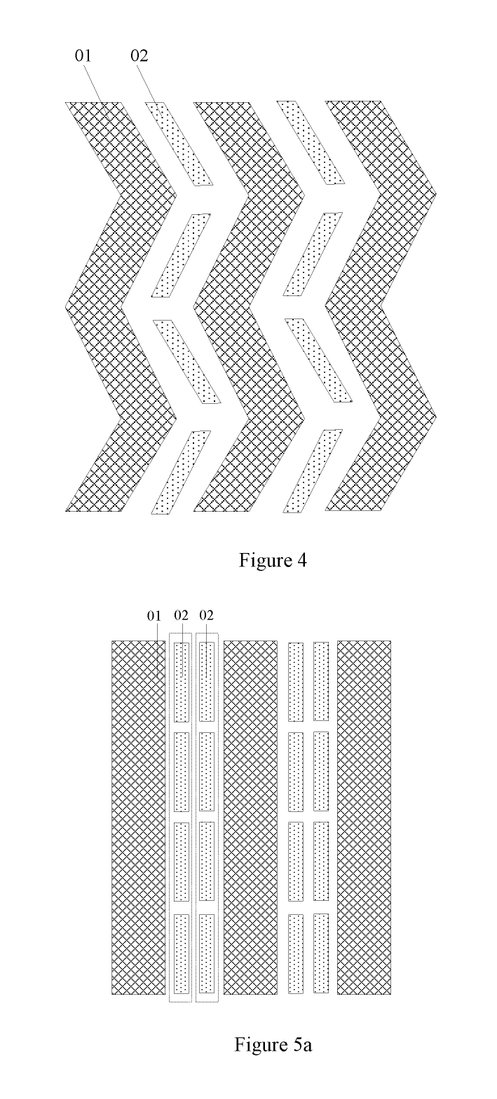

Generally, in specific implementation, in the touch screen panel provided in the embodiments of the present disclosure, as shown in FIGS. 3 and 4, opposite sides of two adjacent touch electrodes 01 are parallel.

Furthermore, in the touch screen panel provided in the embodiments of the present disclosure, as shown in FIGS. 3 and 4, opposite sides of two adjacent touch electrodes 01 are all straight lines or polygonal lines.

Optionally, in order to reduce the risk for short circuits, in the touch screen panel provided in the embodiments of the present disclosure, as shown in FIGS. 5a and 5b, in a gap between adjacent touch electrodes 01, at least one column of isolation electrodes 02 are arranged evenly in an extending direction of the gap. Beside, the respective shapes of the isolation electrodes 02 are rectangular or parallelogrammic.

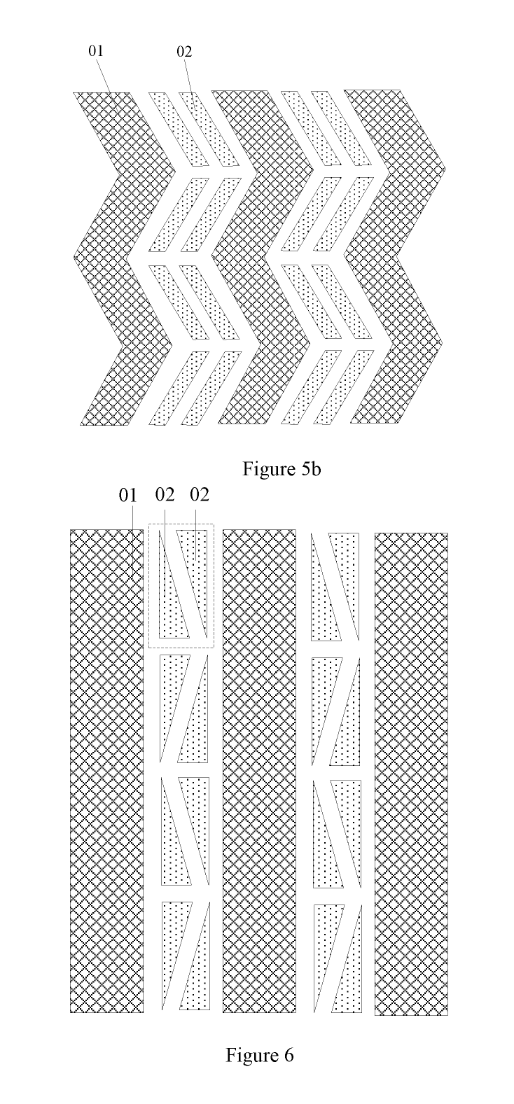

Optionally, in order to reduce the risk for short circuits, in the touch screen panel provided in the embodiments of the present disclosure, as shown in FIG. 6, the shapes of the isolation electrodes are triangular, and two isolation electrodes 02 form an isolation electrode group. In each isolation electrode group, three corresponding sides of the two isolation electrodes 02 are parallel respectively. Besides, in a gap between adjacent touch electrodes 01, a column of isolation electrode groups are arranged evenly in an extending direction of the gap.

Based on a same inventive concept, a touch display device is further provided in the embodiments of the present disclosure. The touch display device comprises the touch screen panel provided in the embodiments of the present disclosure. The touch display device can be any product or component having a display function, such as a handset, a tablet computer, a TV, a display, a notebook computer, a digital photo frame, a navigator and so on. For the implementation of the touch display device, embodiments of the touch screen panel can be referred to, which will not be repeated for simplicity.

According to the touch screen panel and the touch display device provided in the embodiments of the present disclosure, several isolation electrodes are arranged in gaps between adjacent touch electrodes, and the isolation electrodes and the touch electrodes are insulated from each other. Therefore, even if a touch electrode and an adjacent isolation electrode are short-circuited during production, such a short circuit will only integrate the isolation electrode into part of the touch electrode while the isolation electrode is still insulated from other touch electrodes, since the isolation electrode is isolated from both other isolation electrodes and other touch electrodes. In this way, the risk of short circuits in the touch screen panel will be greatly reduced.

Obviously, those skilled in the art can make various modifications and variations to the embodiments of the present disclosure without deviating from the spirits and scopes of the present disclosure. Thus if these modifications and variations to the present disclosure fall within the scopes of the claims of the present disclosure and the equivalent techniques thereof, the present disclosure is intended to include them too.

1. A touch screen panel, comprising several touch electrodes arranged in a same layer and being mutually independent, wherein
a plurality of isolation electrodes being mutually independent are arranged at least in gaps between parts of adjacent touch electrodes, and
the isolation electrodes and the touch electrodes are arranged in a same layer and insulated from each other.

2. The touch screen panel according to claim 1, wherein
opposite sides of the isolation electrodes and the touch electrodes adjacent to each other are parallel.

3. The touch screen panel according to claim 2, wherein
gap widths between the isolation electrodes and the touch electrodes adjacent thereto are smaller than 10 μm.

4. The touch screen panel according to claim 2, wherein
opposite sides of two adjacent ones of the isolation electrodes are parallel.

5. The touch screen panel according to claim 4, wherein
gap widths between two adjacent ones of the isolation electrodes are smaller than 10 μm.

6. The touch screen panel according to claim 1, wherein
widths of the isolation electrodes are smaller than 2000 μm in a first direction and smaller than 1000 μm in a second direction, the first direction being perpendicular to the second direction.

7. The touch screen panel according to claim 2, wherein
opposite sides of two adjacent ones of the touch electrodes are parallel.

8. The touch screen panel according to claim 7, wherein
opposite sides of two adjacent ones of the touch electrodes are all straight lines or polygonal lines.

9. The touch screen panel according to claim 8, wherein
in gaps between the adjacent touch electrodes, at least one column of isolation electrodes are arranged evenly in an extending direction of the gaps, and
respective shapes of the isolation electrodes are rectangular or parallelogrammic.

10. The touch screen panel according to claim 8, wherein
shapes of the isolation electrodes are triangular, and two of the isolation electrodes form an isolation electrode group, in which three corresponding sides of the two isolation electrodes are parallel respectively, and
in gaps between the adjacent touch electrodes, a column of isolation electrode groups are arranged evenly in an extending direction of the gaps.

11. The touch screen panel according to claim 1, wherein
all of the isolation electrodes are in a same shape and of a same size.

12. A touch display device, comprising the touch screen panel according to claim 1.

13. The touch display device according to claim 12, wherein
opposite sides of the isolation electrodes and the touch electrodes adjacent to each other are parallel.

14. The touch display device according to claim 13, wherein
gap widths between the isolation electrodes and the touch electrodes adjacent thereto are smaller than 10 μm.

15. The touch display device according to claim 13, wherein
opposite sides of two adjacent ones of the isolation electrodes are parallel.

16. The touch display device according to claim 15, wherein
gap widths between two adjacent ones of the isolation electrodes are smaller than 10 μm.

17. The touch display device according to claim 12, wherein
widths of the isolation electrodes are smaller than 2000 μm in a first direction and smaller than 1000 μm in a second direction, the first direction being perpendicular to the second direction.

18. The touch display device according to claim 13, wherein
opposite sides of two adjacent ones of the touch electrodes are parallel.

19. The touch display device according to claim 18, wherein
opposite sides of two adjacent ones of the touch electrodes are all straight lines or polygonal lines.

20. The touch display device according to claim 12, wherein
all of the isolation electrodes are in a same shape and of a same size.
